(19) United States
(12) Patent Application Publication
(10) Pub. No.: US 2026/0233863 A1
(43) Pub. Date: Aug. 13, 2026

(54) COSMIC RAY PARTICLE SHIELDING DEVICE FOR SPACECRAFT, AND SPACECRAFT

(71) Applicant: Ran HUO, Jinan (CN)

(72) Inventor: Ran HUO, Jinan (CN)

(21) Appl. No.: 19/161,280

(22) PCT Filed: Sep. 10, 2024
(86) PCT No.: PCT/CN2024/118023

§ 371 Date: Sep. 1, 2025

(30) Foreign Application Priority Data
Jul. 10, 2023 (CN) 202310837627.1

(51) Int. Cl. B64G 1/54; H01F 6/06

(52) U.S. Cl. CPC B64G 1/543; H01F 6/06

(57) ABSTRACT

A cosmic ray particle shielding device for a spacecraft, and a spacecraft. The shielding device comprises shielding plate (2) sequentially arranged in the extension direction of the spacecraft, wherein a through hole is provided in the middle of each shielding plate (2) and is used for accommodating the spacecraft, and each shielding plate (2) has an extension portion extending out from the through hole, there is a certain spacing between the shielding plates (2); and several superconducting coils (3) are respectively provided on the side surfaces of each shielding plate (2), and the superconducting coils (3) on the two sides of each shielding plate (2) respectively apply transverse superconducting magnetic fields in opposite directions. Alternatively, shielding plates (2) extending in an angular direction of the spacecraft are replaced with shielding columns, and the shielding columns are tightly arranged.

### CROSS-REFERENCES TO RELATED APPLICATIONS

The present invention claims priority benefits to Chinese Patent Application number 202310837627.1, entitled “A COSMIC RAY PARTICLE SHIELDING DEVICE FOR SPACECRAFT, AND SPACECRAFT”, and filed on Jul. 10, 2023, with the China National Intellectual Property Administration (CNIPA), the entire contents of which are incorporated herein by reference.

### TECHNICAL FIELD

The present invention belongs to the technical field of shielding structures of spacecraft and relates to a cosmic ray particle shielding device for spacecraft, and a spacecraft.

### BACKGROUND

The statements in this section merely provide background information related to the present invention and are not necessarily prior art.

Deep space far from the Earth is full of high-energy charged cosmic ray particles, which can cause significant damage to the astronauts' health, such as inducing cancer. Future manned space flight missions must provide astronauts with radiation shielding against high-energy charged cosmic ray particles.

Manned space activities in existing low Earth orbits (e.g. space stations) are still considerably shielded by the Earth itself and by the Earth's magnetic field, and mission durations are usually only a few months, so an inadequate shielding against cosmic radiation does not yet pose a serious threat to astronauts' health. However, future manned space missions to Mars will be completely out of the shielding from the Earth, and will take at least two years, so radiation shielding is actually one of the main technical difficulties and constraints for such future missions.

Present practical applications of radiation shielding for manned space flight uses traditional shielding materials, such as aluminum or polyethylene, etc. They are made of (continuous) plates placed on the trajectory of particles incident on the human body. Colloquially speaking, astronaut is shielded by the outer shell of the spacecraft. The advantage of this shielding configuration is its technical maturity, and the problem is that the shielding efficiency thereof is rather poor with a shell thickness acceptable for space launch, and it cannot actually achieve effective shielding. If the thickness increases so that the requirements of effective shielding can be meet, the amount of shielding material will be in the range of several hundred tons to several thousand tons, which is actually not feasible for space launch.

Since the 1960s, there has been an idea about shielding that a strong magnetic field generated by superconducting coils (only superconducting materials can avoid current loss) is used to generate Lorentz force on incident charged cosmic ray particles, to make the particle deflected and “bounced” back, avoiding being directed towards astronauts. This type of shielding configuration is referred to as an active shielding, as opposed to the traditional passive shielding described above. Active shielding is still in the stage of simulation research or ground prototype. The advantage of this shielding configuration is that it is no longer necessary to use shielding materials of hundreds of tons. The weight of superconducting coils and their structural supports and coolants is within the range that space launches can withstand, making it possible to achieve sufficient shielding effect. The problem is that generating strong magnetic field that can effectively bounce back the high-energy charged particles requires a large superconducting current, which is very demanding on the superconducting coil itself. For example, yttrium barium copper oxygen (YBCO) was chosen as the final material for the superconducting coil in simulation study because it can carry the largest superconducting current and thus generate the strongest magnetic field compared to other superconducting materials. However, YBCO material is restricted by its physical/chemical properties, so it is difficult to realize large-scale and high-quality industrial production, with high enough uniformity on the micro level and capability for aerospace application.

### SUMMARY

In order to solve those above problems, the present invention provides a cosmic ray particle shielding device for spacecraft and a spacecraft, which combines a traditional shielding plate structure and a strong magnetic field generated by a superconducting coil, thereby simultaneously solving the problem that the weight of the traditional passive shielding is too large for space launch, and the problem that the active shielding of the superconducting coil has too high requirements to be robust enough.

According to some examples, the present invention adopts the following technical solutions.

A cosmic ray particle shielding device for a spacecraft, comprising at least one shielding layer, wherein each shielding layer comprises at least one shielding plate; wherein:
a through hole is provided at a middle portion of the shielding plate for accommodating the spacecraft, and an extension part outwards from the through hole is defined on the shielding plate;
a certain distance is provided between the each shielding plate; and
a plurality of superconducting coils are provided at two sides of each shielding plate, and the superconducting coils respectively arranged on the two sides are able to apply transverse superconducting magnetic fields in opposite directions with respect to each other.

The technical solution of deformation with the same principle can also be adopted.

A cosmic ray particle shielding device for a spacecraft, comprising at least one shielding layer, wherein each shielding layer comprises at least one shielding pillar; wherein:
the spacecraft is arranged at a lower end of the shielding pillar;
a certain distance is provided between each of the shielding pillars; and
a plurality of superconducting coils are provided surrounding each shielding pillar, and superconducting magnetic fields applied by the superconducting coils circle around the shielding pillars.

According to the technical solution above, the passive shielding layer is locally in the form of a thin plate or a pillar, thus a large amount of shielding materials are no longer needed. The shielding materials usage is greatly reduced, facilitating space launches. The superconducting coils are respectively arranged on both sides of the shielding plates or surrounding the shielding pillars, applying transverse superconducting magnetic fields in opposite directions with respect to each other on opposite sides of the shielding plate or pillar. The applied magnetic fields are parallel to the sides of the shielding plates or the shielding pillars and perpendicular to the direction of incident particles, so that the incident positively charged particles are deflected to the shielding plates or pillars no matter on which side they enter. If the particles go across the plates or pillars and exit from the other sides, they can be deflected by the opposite magnetic field towards the shielding plates or pillars again, back and forth. Therefore, the superconducting magnetic fields are no longer to bounce the charged particles back, and the requirements of the corresponding superconducting coil are correspondingly reduced.

As an alternative implementation mode, a material of the shielding plates or the shielding pillars is a shielding material. The shielding material comprises, but are not limit to, aluminum, polyethylene, etc., as well as liquid hydrogen, water, etc., stored in a container of which as a whole is the shielding plate or pillar.

As an alternative implementation mode, the shielding plates or the shielding pillars extend outwards for a distance greater than or equal to 1 meter.

As an alternative implementation mode, the shielding plates or the shielding pillars are provided with a plurality of, the shielding plates are sequentially arranged along an extending direction of the spacecraft, the shielding pillars and the peripheral magnetic fields are arrange on an outer surface of the spacecraft in a honeycomb shape;
a thickness of the shielding plate is at least about one order of magnitude lower than the distance between two adjacent shielding plates, a diameter of the shielding pillar is no more than one third of the distance between centers of two adjacent shielding pillars.

As an alternative implementation mode, each of the shielding layers is sequentially provided from inside to outside.

As an alternative implementation mode, the distance between the two adjacent shielding plates or the two adjacent shielding pillars is in the meters order of magnitude.

As an alternative implementation mode, the shielding plates contain, or the shielding pillars are arranged in, directions pointing to a predetermined position of an astronaut in a cabin of the spacecraft.

As an alternative implementation mode, at least a portion of the superconducting coils is wound in a form of solenoid, a centerline of the solenoid being parallel to the shielding plates, or surrounding the shielding pillar sides.

Further, a size of a single turn of the superconducting coils is equal to or less than a length of a corresponding shielding plate or a corresponding shielding pillar, on the outward extending direction.

As an alternative implementation mode, the shielding structure is of a circumferential distribution shape, the spacecraft is located inside a circumference of the shielding structure, and the magnetic induction lines of the superconducting magnetic fields circle around an outer side surface of the shielding structure for one circle, or the magnetic induction coils surrounding different shielding pillars are closely arranged in a honeycomb shape.

As an alternative implementation mode, the shielding structure described above acts as a single shielding layer, and multiple shielding layers may be arranged outside the spacecraft.

A spacecraft, being externally provided with the device described above.

Compared with the prior art, the invention has the beneficial effects as follows.

The shielding effect of the present invention is somewhat close to that of a continuous shell with a thickness equal to the size of the plate or pillar in the direction of particle incidence, which can be very large compared to a continuous shielding shell of conventional shielding materials, and thus the shielding effect is good. In the space inside this equivalent shell, the traditional shielding material is not continuously filled, but only distributed on the shielding plates or the shielding pillars with their volumes much smaller than the total volume of the shell, so its usage is small and its weight meet the space launch requirement.

Compared with the active shielding of superconducting coils, the present invention does not require the superconducting magnetic field to “bounce” the charged particles back with a deflection angle close to 180°, but only requires the charged particles to be deflected and incident on the traditional shielding plate or pillar, wherein this angle is only tens of degrees. Therefore, the requirements of the magnetic field generated by the coil and the corresponding superconducting current are correspondingly reduced. This makes it possible to use superconducting materials with high robustness (such as MgB₂), which have small superconducting current-carrying capacity and small critical magnetic field, but have good micro uniformity, good mechanical properties, and have been produced on a large scale at a relatively low cost.

In order to make the above objects, features and advantages of the present invention more apparent, preferred embodiments are described in detail below with reference to the accompanying drawings.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of an arrangement structure of shielding plates according to Example 1 of the present invention;

FIG. 2 is a structural diagram of superconducting coils on the shielding plates according to Example 1 of the present invention;

FIG. 3 is a simulation diagram of shielding effect of a single shielding plate according to Example 1 of the present invention;

FIG. 4 is a structural diagram of a single shielding pillar with superconducting coils according to Example 2 of the present invention.

In drawings: 1, spacecraft passenger cabin; 2, single shielding plate; 3, superconducting coils.

Arrows indicate a direction of a superconducting magnetic field.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise/comprising” and/or “include/including” used in this specification indicate that there are features, steps, operations, devices, components, and/or combinations thereof.

### Example 1

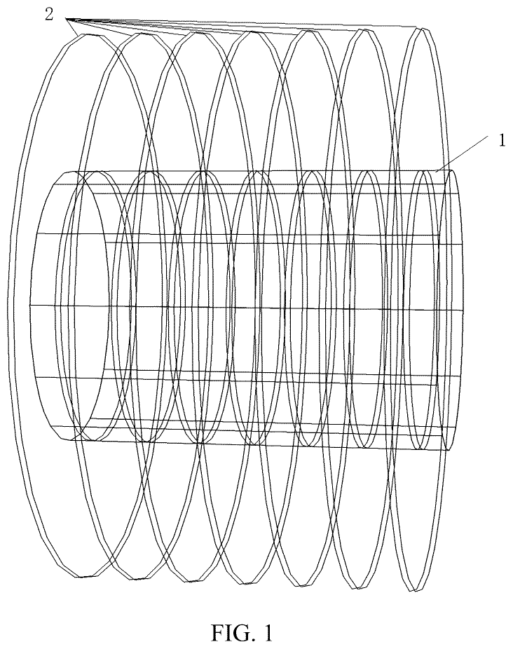

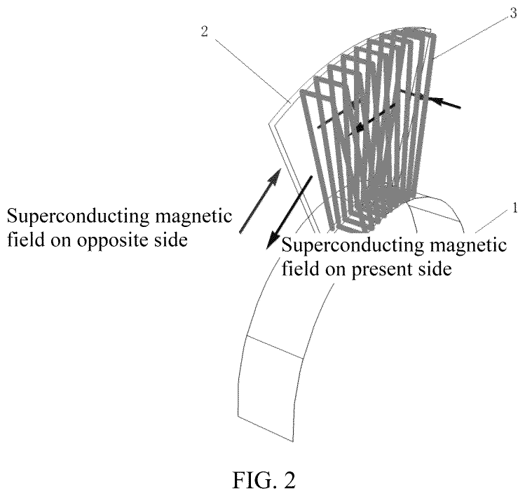

A shielding device for a spacecraft, comprising at least one shielding plate 2 sleeved outside a spacecraft passenger cabin 1, wherein the shielding plate 2 is of a thin plate shape, and as shown in FIG. 1, one side of the spacecraft passenger cabin 1 faces an incident direction of charged particles under consideration perpendicularly, so that the incident direction lies in the plane of the shielding plate 2. As shown in FIG. 2, transverse superconducting magnetic fields in directions opposite with respect to each other are applied on both sides of the shielding plate 2, respectively; the magnetic fields are parallel to the shielding plate 2 and perpendicular to the incident direction of the particles, so that incident positively charged particles are deflected toward the shielding plate 2 regardless of which side of the shielding plate 2 they are incident on. If the particles go across the plate and exit from the other side, they may be deflected by the magnetic field on the opposite side and then enter the shielding plate 2 again, and back and forth.

It should be noted that, in order to ensure the clarity of the drawings, only superconducting coils 3 on one side is shown in FIG. 2, and the superconducting coils 3 on the other side is hidden.

The superconducting coils 3 may extend arbitrarily in a direction of the magnetic field. The superconducting magnetic fields need to satisfy the magnetic induction line closeness condition.

Preferably, the spacecraft passenger cabin 1 and the peripheral shielding structure thereof adopt an axisymmetric structure as a whole, such as a cylinder, a sphere, etc. As the outer boundary of the magnetic field cross section, the superconducting coil extends for one circle (2π) in θ direction of cylindrical coordinate system and closes at a first place.

Further, when the spacecraft passenger cabin 1 is cylindrical, sizes of through holes on each of the shielding plates 2 are uniform, and the shielding plates 2 are arranged in parallel.

Further, when the spacecraft passenger cabin 1 is spherical, the sizes of the through holes on each of the shielding plates 2 are different, and are matched with a shape of the spacecraft passenger cabin 1; and the shielding plates 2 may be sleeved outside a corresponding position of the spacecraft passenger cabin 1, with an arranging direction along a radial direction of the spacecraft passenger cabin 1.

In the present example, the shielding plates 2 and the superconducting coils 3 may be repeated at different positions parallel to this plate, and the entire plane perpendicular to the charged particle beam may be covered with this shielding structure.

In some other examples, a plurality of shielding layers may be provided from the inside to the outside with the spacecraft passenger cabin 1 as center, and each of the shielding layers includes the shielding plates 2 of the structure described above.

It should be noted that, the shielding plates in each of the layers may have the same size and position, or may be different. For example, there is a certain interleaving, or the shielding plates of the each of the layers have different size, etc., which is not exhaustive here.

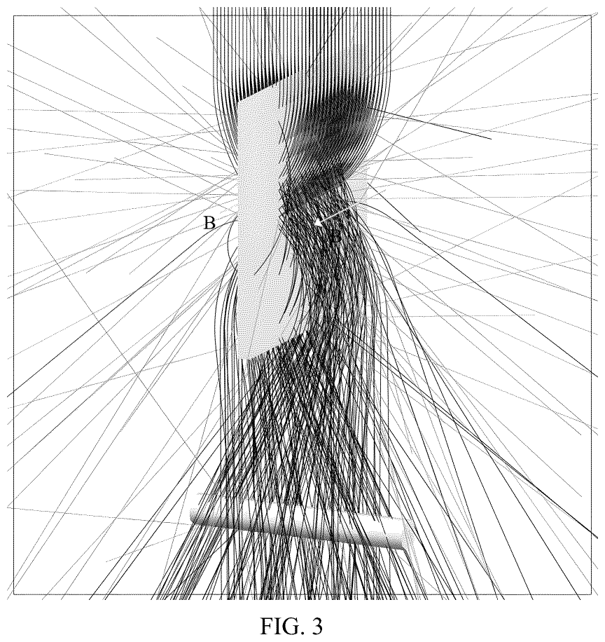

FIG. 3 shows a partial schematic diagram of a shielding module, including physical processes, drawn by Monte Carlo simulation software—Geant4 for high energy physics. The upper approximately lateral plate is a plate of conventional shielding material, with strong magnetic fields in opposite directions generated by superconducting coils (superconducting coils not shown) applied to both sides thereof, and the inner cylinder represents the astronaut's body for the test. Externally incident charged particles, shown by the top-incident line, are magnetically directed toward the conventional shielding material plate over a considerable cross-sectional area, and can be deflected toward the plate again after exiting from the opposite side, and back and forth. The random lines that radiate in all directions are secondary particles produced by the physical process of shielding.

The shielding plates may also be a plurality of, and the shielding plates are arranged in parallel and sleeved.

### Example 2

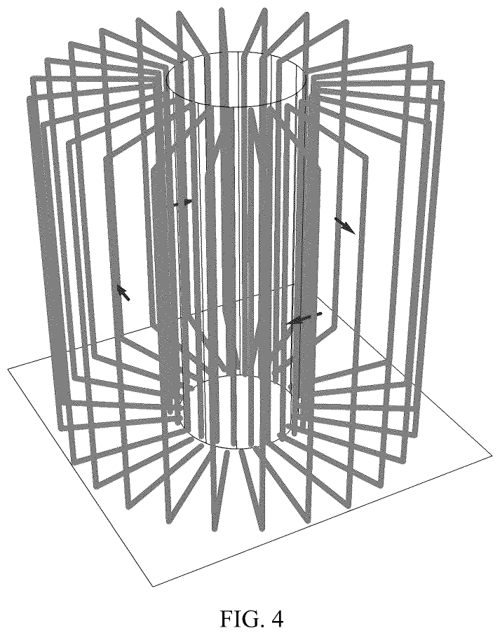

It should be noted that, the shielding structure may not be a plate shape, as shown in FIG. 4, but may be a pillar structure; it should be noted that the pillar structure or the shielding pillar indicated in the present invention, may be a pillar-shaped structure such as cylinder, uniform prism (e.g. hexagonal prism, square prism, etc), etc, may also be conical, hourglass and other non-uniform cross-section structures; the axial direction thereof is located in the direction of incident particles, the spacecraft passenger cabin is located under the shielding structure (not shown in figures), that is, the shielding structure is arranged outside the spacecraft.

The present example will describe by taking the shielding pillars as an example. In the present example, the shielding pillars extend outwards a distance greater than or equal to 1 meter.

The magnetic induction line of the superconducting magnetic field circles around the side thereof. Such incident charged particles repeatedly traverse conventional shielding materials in the radial direction of the pillar.

The axial direction of the shielding pillar is located on direction of the incident particles, and the shielding pillars are arranged outside the spacecraft, that is, the magnetic induction lines of the superconducting magnetic field circle around the outer surface of each shielding pillar.

In some examples, the shielding pillars may be closely arranged in a honeycomb pattern on the outer side of the spacecraft (the figures show a single local shielding structure only). Or each shielding pillar may be arranged in a matrix pattern in sequence, even if the superconducting coils are wound around the outside of the shielding pillar, the overall structure will still maintain with a pillar shape, so the shielding pillars can be arranged in a matrix or honeycomb pattern therebetween.

A diameter of the shielding pillar is no more than one third of the distance between centers of two adjacent shielding pillars.

In some examples, at least a portion of the superconducting coils is wound in a form of solenoid, a centerline of the solenoid circles around the side of the shielding pillar.

A size of a single turn of the superconducting coils is equal to or less than a length of a corresponding shielding pillar, on the outward extending direction.

In some examples, the shielding structure may be provided with multiple layers, that is, the shielding pillars closely arranged in the honeycomb pattern may be a layer of the shielding structure, therefore, there may be a plurality of layers, and each layer sleeved from inside to outside in sequence.

Although the specific embodiments of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. A cosmic ray particle shielding device for a spacecraft, comprising at least one shielding layer, wherein each shielding layer comprising at least one shielding plate;
a through hole is provided at a middle portion of the shielding plate, wherein the through hole is configured for accommodating the spacecraft, and an extension part outwards from the through hole is defined on the shielding plate;
a certain distance is provided between the each shielding plate;
a plurality of superconducting coils are provided at two sides of the each shielding plate, and the superconducting coils respectively arranged on the two sides are configured to apply transverse superconducting magnetic fields in directions opposite with respect to each other.

2. A cosmic ray particle shielding device for a spacecraft, comprising at least one shielding layer, wherein each shielding layer comprising at least one shielding pillar;
an axial direction of the shielding pillar is located on a direction of incident particles, and a shielding pillar structure is arranged outside the spacecraft, magnetic coils are arranged on an outer side of the shielding pillar structure, and magnetic induction lines of a superconducting magnetic field circle around an outer surface of the shielding pillar structure.

3. The cosmic ray particle shielding device for the spacecraft according to claim 1, wherein a material of the shielding plate is a shielding material;
and, a distance the shielding plate extends outwards is greater than or equal to 1 meter.

4. The cosmic ray particle shielding device for the spacecraft according to claim 1, or wherein the shielding layer is provided with multiple layers, the each shielding layer is sleeved from inside to outside in sequence.

5. The cosmic ray particle shielding device for the spacecraft according to claim 1, wherein the shielding plate is provided with multiple, and the multiple shielding devices are arranged along an extending direction of the spacecraft in sequence; and
a thickness of the shielding plate is at least about one order of magnitude lower than a spacing distance between two adjacent shielding plates.

6. The cosmic ray particle shielding device for the spacecraft according to claim 5, wherein the spacing distance between the two adjacent shielding plates is in a meters order of magnitude.

7. The cosmic ray particle shielding device for the spacecraft according to claim 1, wherein the shielding plate is arranged in a direction pointing to a predetermined position of an astronaut in a cabin of the spacecraft.

8. The cosmic ray particle shielding device for the spacecraft according to claim 1, wherein at least a portion of the superconducting coils is wound in a form of solenoid, a centerline of the solenoid is parallel to the shielding plate.

9. The cosmic ray particle shielding device for the spacecraft according to claim 8, wherein a size of a single turn of the superconducting coils is equal to or less than a distance the corresponding shielding plate on the outward extending direction.

10. A spacecraft, comprising the cosmic ray particle shielding device for the spacecraft according to claim 1 being provided an external thereof.

11. The cosmic ray particle shielding device for the spacecraft according to claim 2, wherein a material of the shielding pillar is a shielding material;
and, a distance the shielding pillar extends outwards is greater than or equal to 1 meter.

12. The cosmic ray particle shielding device for the spacecraft according to claim 2, wherein the shielding layer is provided with multiple layers, the each shielding layer is sleeved from inside to outside in sequence.

13. The cosmic ray particle shielding device for the spacecraft according to claim 2, wherein the shielding pillar is provided with multiple, and the multiple shielding pillars are closely arranged in a matrix or honeycomb pattern at the outer side of the spacecraft; and
a diameter of the shielding pillar is no more than one third of a spacing distance between centers of two adjacent shielding pillars.

14. The cosmic ray particle shielding device for the spacecraft according to claim 13, wherein the spacing distance between the two adjacent shielding pillars is in a meters order of magnitude.

15. The cosmic ray particle shielding device for the spacecraft according to claim 2, wherein the shielding pillar is arranged in a direction pointing to a predetermined position of an astronaut in a cabin of the spacecraft.

16. The cosmic ray particle shielding device for the spacecraft according to claim 2, wherein at least a portion of the superconducting coils is wound in a form of solenoid, a centerline of the solenoid circles around the sides of the shielding pillar.

17. The cosmic ray particle shielding device for the spacecraft according to claim 16, wherein a size of a single turn of the superconducting coils is equal to or less than a distance the corresponding shielding pillar on the outward extending direction.

18. A spacecraft, comprising the cosmic ray particle shielding device for the spacecraft according to claim 2 being provided an external thereof.
